(19) United States
(12) Patent Application Publication
(10) Pub. No.: US 2011/0219109 A1
(43) Pub. Date: Sep. 8, 2011

(54) SYSTEM AND METHOD FOR SHARING TRANSPARENT PROXY BETWEEN ISP AND CDN

(75) Inventors: Ronni Zehavi, Sunnyvale, CA (US); Udi Trugman, Alfe-Menashe (IL); David Drai, Kfar Yona (IL)

(73) Assignee: Cotendo, Inc., Sunnyvale, CA (US)

(21) Appl. No.: 13/126,688

(22) PCT Filed: Oct. 26, 2009
(86) PCT No.: PCT/IB2009/054727

§ 371 Date: May 25, 2011

Related U.S. Application Data
(60) Provisional application No. 61/193,092, filed on Oct. 28, 2008.

(51) Int. Cl. G06F 15/173

(52) U.S. Cl. 709/223

(57) ABSTRACT

A system and a method for sharing a proxy between an ISP (Internet Service Provider) or other Internet point of presence, and a CDN (content delivery network).

### FIELD OF THE INVENTION

The present invention relates to a system and a method for sharing a transparent proxy, and in particular to such a transparent proxy between an ISP (Internet service provider) and CDN (content distribution network).

### BACKGROUND OF THE INVENTION

Due to the growth of the Internet, access to data has become very complicated. Content may be requested by users operating computers that must travel through many sub networks in order to arrive to the end user computer from the content provider.

In order to optimize the access to content via the Internet, a CDN (content distribution network) is frequently used for providing delivering content such as Web pages, streaming media and applications to the user's computer. Such network is composed of geographically distributed content delivery nodes that are arranged for efficient delivery of content on behalf of third party content providers. A request from an end user for given content is directed from the computer of the end user to the Internet through a “point of presence”, such as an Internet service Provider (ISP), and hence to a server of the CDN (rather than being sent to the server of the content provider itself). Such routing minimizes the response time for data requests and provides high quality bandwidth for streaming media. Also such networks provide more efficient and cost-effective distribution to the computers of end users. Unfortunately such connections still result in a great deal of traffic between the point of presence and the content server.

U.S. Pat. No. 7,149,797 issued on Dec. 12, 2006, hereby incorporated by reference as if fully set forth herein, teaches sharing the CDN infrastructure between the CDN service provider and a network service provider (NSP) such that one or more private CDNs share infrastructure of a large CDN which manages all the private CDNs. FIG. 1 of this patent describes a basic CDN infrastructure as is known in the art. However, this patent does not solve the problem of traffic between the point of presence of the ISP and the CDN network.

### SUMMARY OF THE INVENTION

There is an unmet need for, and it would be highly useful to have, a system and a method for minimizing the traffic between an Internet point of presence, such as an ISP (Internet service provider) and a CDN (content delivery network).

The present invention overcomes these drawbacks of the background art by providing a system and method for sharing a transparent proxy between ISP and the CDN.

According to one embodiment of the present invention, the end user requests are routed to a proxy which resides in one or more servers, or even a “server farm”, of the ISP. Such requests can be, but are not limited to, HTTP (Hypertext Transfer Protocol) requests for a new web page, any type of content item, or for streaming data, which may be collectively referred to herein as content objects. According to this embodiment popular content is maintained at the transparent proxy, for example more preferably in the local cache of the proxy. When a request for such content is received by the proxy from an end user computer that is connected to or otherwise receives Internet connectivity services from the ISP, the proxy retrieves the information and transfers the information directly to the end user. Thus there is no need for outbound traffic, for fetching the data from a server through the Internet, in such cases; preferably such outbound traffic is not performed.

According to other embodiments of the present invention, more storage is allocated for the CDN customer at the ISP, and preferably at the transparent proxy, such that traffic in the CDN network is reduced. Such a reduction in benefits also has the advantage (without wishing to be limited to a closed list) of limiting costs for the CDN.

According to other embodiments of the present invention preferably at least one or more CDN functions, and optionally and more preferably most of the CDN functions, are implemented in the transparent proxy at the ISP. Such functions include but is not limited to control of one or more cache parameters, including but not limited to control of TTL (time to live or period of storage), managing security parameters, invalidating or removing an object from the cache through flushing and so forth.

According to other embodiments of the present invention the CDN and ISP can optionally cooperate in sharing statistical information about end user habits, preferred websites or other content and the like. For example, the ISP could send the number and frequency of requests for an object, provide a full log of information to the CDN (preferably only for requests and/or actions related to the CDN, its customers and/or its activities) and so forth.

As described herein an ISP (An Internet service provider) is a company which primarily offers access to the Internet using any type of data communication to their customers, whether through dial-up telephone access, wireless access, wired access (such as cable, broadband or the like), satellite access or any other type of access. As used herein, the term “ISP” may optionally refer to any service provider or connector which enables end user computers or other client computers to connect to the Internet, including any type of POP.

As used herein, a POP (Internet point of presence) is an access point to the Internet. It is typically a physical location that houses servers, routers, ATM switches and digital/analog call aggregators. ISPs typically have multiple POPs.

Unless otherwise defined, all technical and scientific terms used herein have the same meaning as commonly understood by one of ordinary skill in the art to which this invention belongs. The materials, methods, and examples provided herein are illustrative only and not intended to be limiting. Implementation of the method and system of the present invention involves performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

Although the present invention is described with regard to a “computer” on a “computer network”, it should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager, TV decoder, game console, digital music player, ATM (machine for dispensing cash), POS credit card terminal (point of sale), electronic cash register. Any two or more of such devices in communication with each other, and/or any computer in communication with any other computer, may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic drawing of the system;

FIG. 2 is an exemplary diagram describing the flow of data in the system; and

FIG. 3 is an exemplary diagram describing the propagation of data from a content provider to the database of the ISP.

### DESCRIPTION OF THE PREFERRED EMBODIMENTS

The present invention, in at least some embodiments, relates to a system and a method for sharing a transparent proxy between an ISP (Internet service provider) and CDN, for example (and without wishing to be limited by a closed list) for improving the performance of content delivery to the customers of the CDN and reducing cost.

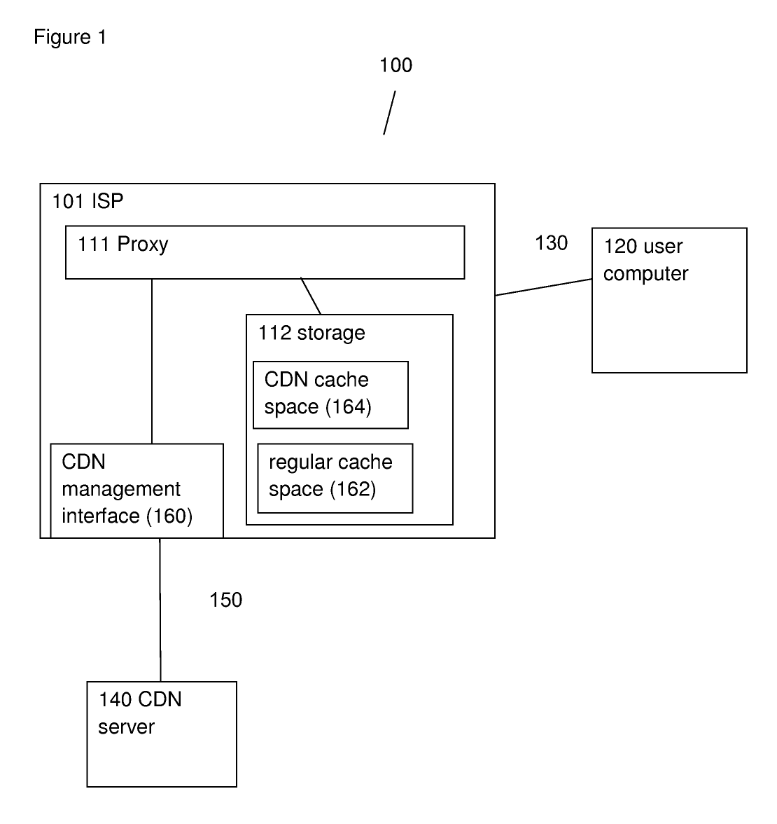

Referring now to the drawings, FIG. 1 is a schematic drawing of the system according to some embodiments of the present invention. System 100 features an ISP 101 (Internet service provider), although ISP 101 could optionally be any type of POP (Internet point of presence). Furthermore, the structure shown herein may optionally be replicated for each POP of ISP 101. ISP 101 preferably features proxy 111 which communicates with a local storage 112. Local storage 112 can optionally reside in a separate server (not shown). Preferably objects are provided from a CDN, represented by CDN server 140, of which a plurality may be present, to proxy 111. Proxy 111 receives new data objects through an Internet connection 150 as shown. Proxy 111 caches the information in the local storage 112.

When a request for data (such as a web page or streaming data) arrives from a user computer 120 which receives Internet service from ISP 101, the request is first received by proxy 111. If proxy 111 is transparent, which is a preferred embodiment of the present invention, then no special prior action or setting on user computer 120 is required; alternatively, if proxy 111 is optionally not transparent, then user computer 120 is preferably set with any necessary parameters or settings to permit direct communication with proxy 111.

Proxy 111 searches for the object in the local storage 112. If the object is found, the proxy 111 responds to the user's request (made through user computer 120) and sends the object to user computer 120; otherwise, the proxy 111 forwards the request to Internet 150, for example to a CDN server 140. User computer 120 is optionally connected to ISP 101 using any type of computer network 130 as previously described.

As noted above, objects are provided from a CDN, represented by CDN server 140, to local storage 112 according to one or more parameters. Objects for example are optionally and preferably provided according to popularity, frequency of requests from the user computers 120 connected to ISP 101, expected popularity and so forth. Also statistical analyses of actual usage are preferably shared between ISP 101 and the CDN itself, for example in order to improve local service through ISP 101. If an object is to be removed from the CDN, then preferably CDN server 140 communicates with proxy 111 to remove the object.

Optionally and preferably, CDN server 140 provides such objects to ISP 101 through a CDN management interface 160, which preferably resides at ISP 101. In addition, CDN server 140 communicates with ISP 101 regarding objects to be removed from local storage 112 through CDN management interface 160.

CDN management interface 160 preferably communicates directly with proxy 111 to add and remove objects from local storage 112. More preferably, local storage 112 comprises a regular cache space 162, for storing any type of data or content as is currently known in the art; and a CDN cache space 164, for storing objects received from the CDN itself. CDN management interface 160, and hence the CDN itself, optionally and preferably controls storage of objects in CDN cache space 164, including determining when to remove such objects. By “cache space” it is meant any type of storage or cache, which may optionally comprise more than one such storage or cache; and/or dynamic storage or cache that is not fixed and/or which may be “virtual”, in the sense that designation as any particular type of cache space may be determined with regard to each object individually or to a collection of a plurality of objects.

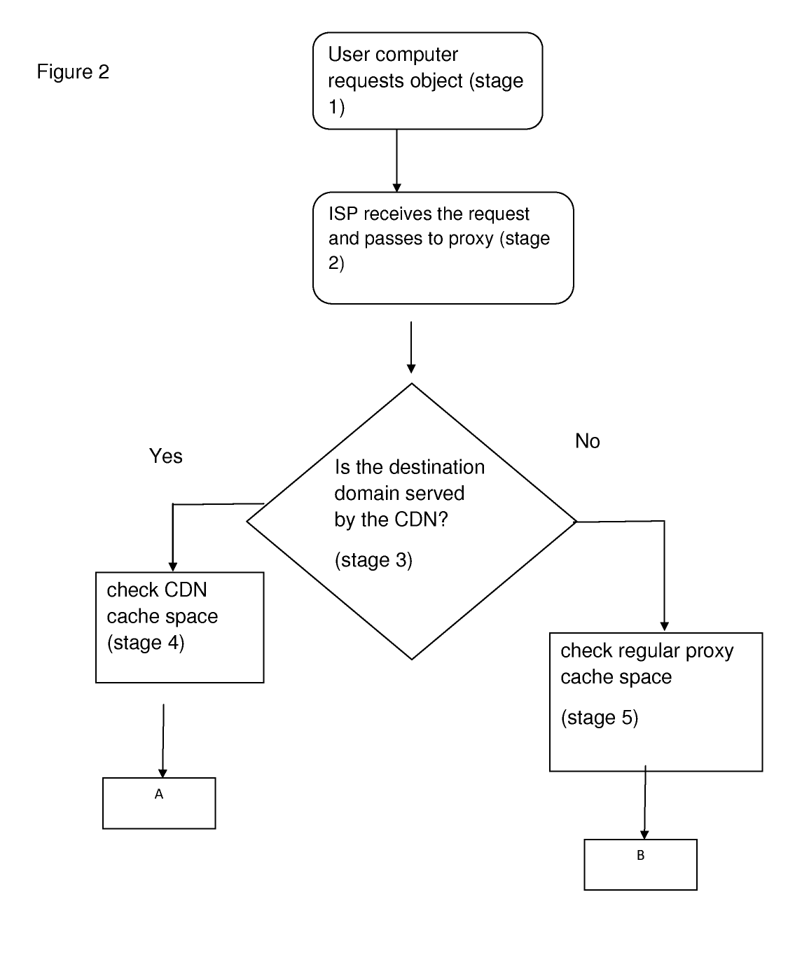

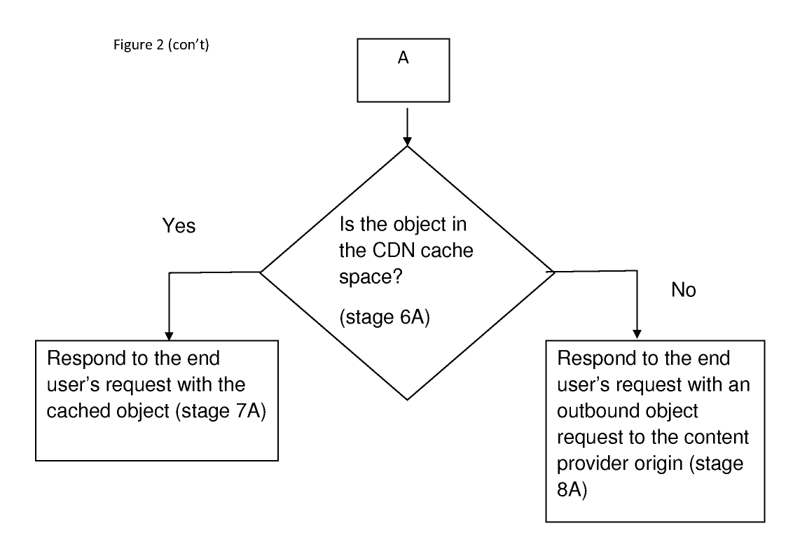

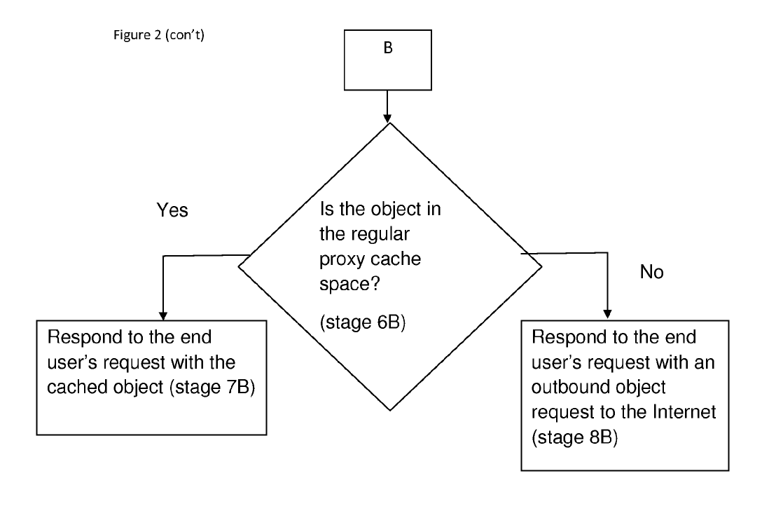

FIG. 2 is an exemplary diagram describing the flow of data in the system. In stage 1 the user operates a user computer, which sends a request for a content object, for example as part of a web page and/or as a separate content item. In stage 2 the request is received by the ISP and is directed to is the proxy. In stage 3 the domain of the destination of the original request for the object is checked. If this destination domain is served by the CDN then the CDN cache of the local cache is checked (stage 4), after which the method proceeds to flow “A”. Otherwise the regular proxy cache is checked (stage 5), after which the method proceeds to flow “B”.

In stage 6A, in which the flow proceeds with regard to the CDN proxy cache, a decision is made, according to the search results. If the object is found, the proxy sends a response to the end user computer with the requested object (stage 7A). Otherwise the request is preferably forwarded to the content provider origin site or server, for delivery by the content provider to the user computer (and optionally, additionally or alternatively, to the proxy at the ISP) (stage 8A).

In stage 6B, in which the flow proceeds with regard to the regular proxy cache, a decision is made, according to the search results. If the object is found, the proxy sends a response to the end user with the requested object (stage 7B). Otherwise the request is preferably forwarded to the Internet in stage 8B (if the domain is served by a different CDN, the request is preferably forwarded to the nearest replica of that CDN).

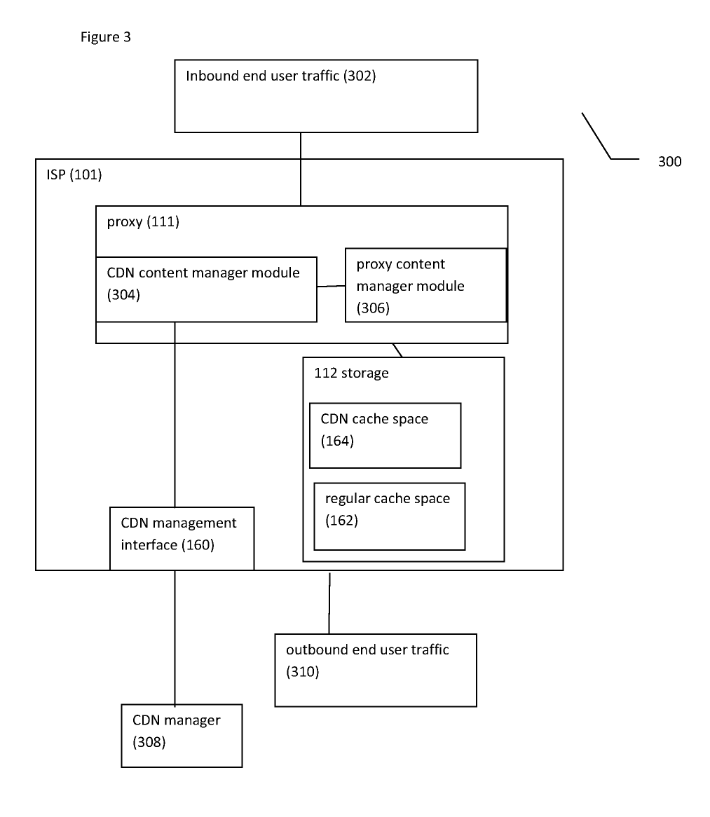

FIG. 3 is an exemplary diagram describing the propagating of data from the CDN to the point of presence on the Internet, such as an ISP for example. As shown, a system 300 features inbound end user traffic (302), which is received by ISP 101. Within proxy 111, a CDN content manager module 304 and a proxy content manager module 306 manage content that is to be stored at proxy 111 and then distributed to end users (shown as outbound end user traffic 310). Specifically CDN content manager module 304 receives content and instructions regarding this content from the CDN (shown as CDN manager 308, as opposed to the complete CDN, for the sake of simplicity only), again through CDN management interface 160. CDN content manager module 304 then instructs proxy content manager module 306 regarding content to be stored in database 112. Proxy content manager module 306 controls all of the content at ISP 101, while CDN content manager module 304 is only responsible for content from the CDN itself.

The CDN, through CDN manager 308, can preferably decide to increase or decrease the TTL (time to live) of the content more than proxy 111 itself, optionally depending upon the content provider which uses the CDN and hence which preferably provides input regarding such parameters as TTL for managing the local CDN cache space 164.

Without wishing to be limited by certain functionality or closed list of benefits, this embodiment is beneficial to the ISP, content provider and CDN since for every cache optimization performed by the content provider, caching is rendered more efficient for all of the parties involved, including the end user customer, in turn reducing the cost and amount of unnecessary outbound traffic. Furthermore, the content provider may optionally receive further services and/or an additional layer or level of service from the CDN, without requiring additional construction of infrastructure by the CDN and also without requiring the CDN to incur additional bandwidth costs.

While the invention has been described with respect to a limited number of embodiments, it will be appreciated that many variations, modifications and other applications of the invention may be made.

What is claimed is:

1. A method for managing traffic at a point of presence on a computer network to an end user computer, comprising:
a. Providing a proxy at said point of presence, wherein said proxy is also accessible to a CDN (content delivery network);
b. Placing one or more content objects in said proxy by said CDN;
c. Rerouting a content request for a content object from the end user computer to said point of presence through said proxy; and
d. If said content object is available in said proxy, transferring said content object from said proxy directly to said end user computer.

2. The method of claim 1 wherein if said content object is available in said proxy, a request is not made to said CDN or to a third party for said content object.

3. The method of claim 2, wherein if said content is not available at said proxy, the method further comprises forwarding said end user request to said CDN or to said third party.

4. The method of claim 3, wherein said rerouting said content request further comprises determining a destination domain of said content request;
determining whether said destination domain is served by said CDN; and if said destination domain is served by said CDN, determining whether said content object is available in said proxy.

5. The method of claim 4, wherein if said destination domain is not served by said CDN, determining whether said content object is available in a regular cache space at said point of presence.

6. The method of claim 4 or 5, further comprising routing said request to said destination domain if said content object is not available at said point of presence.

7. The method of claim 1 wherein said request comprises an HTTP request.

8. The method of claim 7 wherein said HTTP request comprises a request for a new web page, content item, or streaming data.

9. The method of claim 1 wherein said point of presence is an ISP or is present at an ISP.

10. The method of claim 1, further comprising managing said storage of said one or more content objects at said proxy by said CDN.

11. The method of claim 10, wherein said managing comprises determining one or more parameters for said storage at said proxy by said CDN.

12. The method of claim 11, wherein said one or more parameters comprise one or more of control of TTL (time to live), one or more security parameters, and control of invalidating or removing an object from the cache through flushing.

13. The method of claim 1, further comprising performing a statistical analysis of a plurality of requests from a plurality of end user computers to said proxy by said ISP or said CDN.

14. The method of claim 13, wherein said performing said statistical analysis comprises determining a number and frequency of requests for an object by said ISP.

15. The method of claim 1, wherein said one or more content objects are selected according to popularity of requests.

16. The method of claim 1, wherein said one or more content objects are selected for minimizing the traffic at the point of presence.

17. A system for managing outbound traffic at a point of presence on a computer network, the system comprising:
a. A proxy at said point of presence, said proxy comprising content storage;
b. A manager at said proxy for managing content;
c. A CDN (content delivery network) for propagating content from one or more content provider servers to said proxy for storage in said content storage;
d. An end user computer for requesting content from the point of presence, wherein said request is rerouted to said proxy, such that if available, said content is provided from said content storage;
e. A first computer network for connecting said CDN to said proxy; and
f. A second computer network for connecting said proxy to said end user.

18. The system of claim 17, wherein said first and/or said second computer networks comprise one or more of the Internet, a local area network and a wide area network.

19. The system of claim 17 or 18, further comprising a CDN interface at said proxy for interfacing with said CDN.

20. The system of claim 19, wherein said CDN interface supports management of said content storage by said CDN.

21. The system of claim 20, wherein a portion of said content storage is allocated to said CDN, such that only said portion is accessible to said CDN.

22. The system of any of claims 17-20, wherein said point of presence is an ISP or is present at an ISP.

23. A method for propagating content to a proxy at a point of presence; comprising:
a. Propagating data content from one or more content providers to the proxy;
b. Caching said content in a local cache at said proxy; and
c. Removing objects from said local cache according to TTL (time to live).

24. The method of claim 23 wherein objects are provided according to one or more of popularity, frequency of requests from end user computers connected to the point of presence and expected popularity.

25. The method of claim 23 wherein said propagated data is transferred from said one or more content providers to a CDN (content delivery network) and from said CDN to said proxy.

26. The method of claim 25, further comprising improving local services by sharing statistical analyses of actual usage between said point of presence and the CDN.

27. The method of claim 25, wherein said removing of said object from said proxy is instructed by said CDN.
